(19) United States
(12) Patent Application Publication
(10) Pub. No.: US 2015/0140252 A1
(43) Pub. Date: May 21, 2015

(54) VARIABLE INTERLAYER LAMINATE PANELS AND METHODS OF FORMING THE SAME

(71) Applicant: 3form, Inc., Salt Lake City, UT (US)

(72) Inventors: R. Talley Goodson, Salt Lake City, UT (US); Rocky Joseph Lopez, Sandy, UT (US); Douglas Mitchell Underwood, Bountiful, UT (US); John E.C. Willham, Sandy, UT (US)

(73) Assignee: 3FORM, INC., Salt Lake City, UT (US)

(21) Appl. No.: 13/821,472

(22) PCT Filed: Sep. 29, 2011
(86) PCT No.: PCT/US2011/054058

§ 371 Date: Mar. 7, 2013

(51) Int. Cl. B32B 3/18; B32B 37/18; B32B 37/06

(52) U.S. Cl. CPC B32B 3/18; B32B 37/06; B32B 37/185; B32B 2451/00
USPC 428/48; 156/308.2

(57) ABSTRACT

A variable interlayer laminate panel can include resin material derived from other resin panels, enabling use of waste trimmings from the manufacture of the other resin panels. Implementations therefore enable manufacturers to produce high-fashion but waste conscious resin panels that have a high degree of recycled content. In one implementation, a manufacturer forms a laminate panel by positioning a plurality of independent resin portions over a first resin substrate, and then by positioning a second resin substrate over the resin portions. The resin portions comprise embedded decorative elements, and at least two different resin portions comprise different types of decorative elements. The manufacturer then forms the laminate panel through the application of pressure and heat. The resulting panel has a variable interlayer formed from the independent resin portions. The laminate panel is usable as part of a panel system.

### CROSS-REFERENCE TO RELATED APPLICATIONS

The present invention is a 371 U.S. National Stage of PCT Application No. PCT/US2011/054058, filed Sep. 29, 2011 entitled “VARIABLE INTERLAYER LAMINATE PANELS AND METHODS OF FORMING THE SAME” which claims the benefit of and priority to U.S. Provisional Application No. 61/387,209, filed Sep. 28, 2010, entitled “Laminated Sheets Containing Randomized Variable Interlayers,” the entire content of which is incorporated by reference herein.

### BACKGROUND OF THE INVENTION

1. The Field of the Invention

This invention relates to apparatus, methods, and systems for laminate panels produced from existing resin portions, such as, for example, recycled waste trimmings resulting from the production of other laminate panels.

2. Background and Relevant Art

Recent trends in building design involve using one or more sets of decorative panels to add to the functional and/or aesthetic characteristics of a given structure of design space. For instance, some recent architectural designs have implemented synthetic thermoplastic polymeric resin panels for use as partitions, displays, barriers, lighting diffusers, decorative finishes, etc. Polymeric resin panel materials may include, for example, poly vinyl chloride (PVC); polyacrylate materials such as poly (methyl methacrylate) (PMMA); polyester materials such as poly (ethylene-co-cyclohexane 1,4-dimethanol terephthalate) (PET) or poly (ethylene-co-cyclohexane 1,4-dimethanol terephthalate glycol) (PETG); glycol modified polycyclohexylenedimethlene terephthalate (PCTG); 1,4-cyclohexanedimethanol (CHDM); polycarbonate (PC) materials, and the like. Materials used in producing polymeric resin panels may also include any number of similar resins or resin alloys that trace their component origins to derivatives of petroleum processing.

Resin panels are popular compared with decorative cast or laminated glass panels, since resin panels are generally more resilient and less costly than glass panels, while having a similar transparent, translucent, or decorative appearance. Decorative resin panels may also provide greater design flexibility as compared with glass panels, at least in terms of color choices, degree of texture, thickness, and overall physical characteristics, such as flexibility and impact resistance. Furthermore, decorative resin panels have wide utility since manufacturers can easily and inexpensively form and fabricate single or multi-layer laminate resin panels that include a large variety of artistic designs, images, shapes, structures, and assemblies. Furthermore, manufacturers can economically produce resin panels as either flat sheets or three-dimensional (i.e., curved or shaped) formations, that can potentially include compound curvatures. As a result, resin panels have a fairly wide functional and aesthetic utility, and provide designers and architects with the ability to readily change the design and function of new and existing structures.

When producing flat resin sheets, manufacturers often produce the sheets in standard sizes, which may vary between large sheets (e.g., 5′×10′) to small tiles (e.g., 6″×6″). Manufacturers can even produce custom-sized resin sheets as ordered by a purchaser. In either case, during the manufacturing process, manufacturers typically form resin sheets that are larger than the standard or customer-defined sizes eventually sold. This can be due to the size of the manufacturing equipment used to create the resin sheets, or out of a desire to trim the excess material from one or more edges of the resin sheets. Edge trimming can create a clean edge on the final product, and can provide squared and uniform panel geometries suitable for commercial distribution.

Unfortunately, this practice creates a sizeable waste stream, including edge trimmings (i.e., resin material trimmed from one or more edges of resin sheets) and other left-over resin portions not sold as a final consumer product. The size of this waste stream can be exasperated when producing custom-sized resin panels, as the portion(s) of a resin sheet used for the final panel product(s) may be significantly smaller than the originally-produced resin sheet. Panel manufacturers have conventionally sent waste trimmings to landfills due, at least in part, to the fact that waste trimmings are difficult to incorporate into traditional recycling streams. This is a particular problem for the environment, as resin materials do not typically break down or degrade for significant time durations. Not only do resin materials degrade at poor rates, but the source of some common resins (i.e., fossil-based hydrocarbons, such as petroleum), is generally thought to be non-replenishing, and continually under pressure of exhaustion and market instability.

### BRIEF SUMMARY OF THE INVENTION

Implementations of the present invention solve one or more of the foregoing or other problems in the art with systems, methods, and apparatus configured to produce variable interlayer laminate panels including resin portions sourced from other resin panels. Specifically, implementations of the present invention comprise apparatus and methods for laminating a plurality of resin portions, sourced from other resin panels, between two resin sheets using primarily heat and pressure. In at least one implementation, the resin portions can include waste trimmings, enabling a manufacturer to produce a high-fashion, but waste-conscious resin panel that the manufacturer can sell and market as having a high percentage of recycled content.

For example, one implementation of a method of manufacturing a laminate resin panel can involve a manufacturer forming a panel assembly, including the manufacturer positioning a first resin substrate in the panel assembly. The manufacturer can also position a plurality of independent resin portions over the first resin substrate. Each independent resin portion can comprise embedded decorative elements, with at least two different resin portions comprising different types of decorative elements. The manufacturer can then position a second resin substrate over the plurality of independent resin portions. Subsequently, the manufacturer can apply a combination of heat and pressure to the panel assembly until the resin portions fuse together and also fuse to the first resin substrate and to the second resin substrate.

An implementation of a laminate panel can comprise a first resin substrate and an opposing second resin substrate. The laminate panel can also comprise an interlayer positioned between and fused to the first resin substrate and the opposing second resin substrate. The interlayer can comprise a plurality of resin portions, including a first resin portion fused to a second resin portion. The first resin portion can have a first decorative element embedded therein, and the second resin portion can have a second decorative element embedded therein, the second decorative element being different from the first decorative element.

Furthermore, a panel system can include a laminate panel and one or more fasteners attaching the laminate panel to a support structure. The laminate panel can include a first resin substrate and an opposing second resin substrate, with an interlayer positioned between and fused to the first and second resin substrates. The interlayer can comprise a plurality of fused resin portions, including a first resin portion that comprises a first embedded decorative element and a second resin portion that comprises a second embedded decorative element. The second embedded decorative element is of a different material than the first embedded decorative element.

Additional features and advantages of exemplary implementations of the present invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exploded perspective view the layers of a variable interlayer laminate panel, in accordance with an implementation of the present invention;

FIG. 2A illustrates an exploded side view of the layers of a variable interlayer laminate panel of FIG. 1;

FIG. 2B illustrates an side view of a variable interlayer laminate panel formed from the layers of FIG. 2A, in accordance with an implementation of the present invention;

FIG. 3A-3B illustrate top views of resin panels which a manufacturer may use to source resin portions, in accordance with an implementation of the present invention;

FIGS. 4A-4B illustrate top views of resin panels which a manufacturer may use to source resin portions, along with dashed lines indicating how the manufacturer may cut or trim the panels, in accordance with an implementation of the present invention;

FIG. 5A illustrates a top view of a resin edge trimming, in accordance with an implementation of the present invention;

FIG. 5B illustrates a top view of the resin edge trimming of FIG. 5A once a manufacturer has further trimmed the edge trimming for use in a laminate resin panel, in accordance with an implementation of the present invention;

FIG. 6A illustrates an exploded top view of an exemplary arrangement of resin portions making up a variable interlayer, in accordance with an implementation of the present invention;

FIG. 6B illustrates a top view of the arrangement of resin portions of FIG. 6A as arranged for the variable interlayer, in accordance with an implementation of the present invention;

FIG. 7 illustrates a flowchart of acts in a method of manufacturing a laminate panel in accordance with an implementation of the present invention; and

FIG. 8 illustrates a panel system including a variable interlayer laminate panel in accordance with an implementation of the present invention.

### DETAILED DESCRIPTION OF THE PREFERRED EMBODIMENTS

Implementations of the present invention solve one or more of the foregoing or other problems in the art with systems, methods, and apparatus configured to produce variable interlayer laminate panels that include resin portions sourced from other resin panels. Specifically, implementations of the present invention comprise apparatus and methods for laminating a plurality of resin portions, sourced from other resin panels, between two resin sheets using primarily heat and pressure. In at least one implementation, the resin portions can include waste trimmings, enabling a manufacturer to produce a high-fashion, but waste-conscious resin panel that the manufacturer can sell and market as having a high percentage of recycled content.

In general, and as understood more fully herein, a manufacturer can produce variable interlayer laminate panels having a plurality layers, including a first outer layer (i.e., a first resin substrate) and a second opposing outer layer (i.e., a second resin substrate). Positioned between the outer layers, the variable interlayer laminate panel can include at least one variable interlayer, such as a decorative interlayer, made up of a plurality of independent pieces or portions of resin material. Preferably, one or more of the outer layers comprise a substantially transparent resin material that provides at least a partial view of the variable interlayer. The pieces forming the variable interlayer can also comprise an at least partially transparent resin material, as well as one or more decorative elements (either resin or non-resin). At least one of the pieces or portions making up the interlayer can originate from other resin panels, such as one or more waste trimmings generated while manufacturing one or more other resin panels.

As such, a part, or even all, of the resin material forming the variable interlayer can comprise pre-consumer recycled material. Reuse of waste trimmings, such as edge trimmings and other leftover resin portions, by a manufacturer producing resin panels can yield gains for the manufacturer, for consumers, for the environment, and for others. Gains include, for example, cost savings for manufacturers and consumers brought about through an overall reduction in the amount of source resin material required to produce resin panels, as well a reduction in disposal costs. Gains also include benefits to the environment and to society as a whole brought about by a reduction in waste and a reduction in the use of fossil-based hydrocarbon resources when producing resin panels. The production of resin panels with recycled content can also generate goodwill for the manufacturer and for consumers using the panels, and can expand the market for resin panels to include the growing community of environmentally-conscious consumers.

In addition, producing resin panels having a high percentage of recycled resin content can help manufacturers and consumers alike meet professional certification with environmentally-conscious organizations. Many manufacturers, suppliers, architects, designers, and other businesses favor manufacturing methods and materials that exhibit environmental stewardship and responsibility. For example, LEADERSHIP IN ENERGY AND ENVIRONMENTAL DESIGN (LEED) certification tallies points for environmentally sound building practices, such as the use of recycled industrial waste, in a building project. LEED provides more points for use of higher percentages of recycled content, which can contribute to a “Green Building” certification, a designation that is important as a value-add for many designers, architects, and building owners. Material suppliers that offer building supplies with recycled material content may enjoy a significant market advantage over their competitors as environmental concerns and certifications continue to become an important part of material specification.

As a preliminary matter, as used herein the phrases “resin substrate” and “resin sheet” mean single or multi-layer substrates or sheets formed from thermoplastic polymers (or alloys thereof). Specifically, such materials include but are not limited to, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), cellulose-based polymers (cellulose acetate, cellulose butyrate or cellulose propionate), or the like. Furthermore, resin substrates and sheets can include other thermoplastic polymers or thermoplastic polymer blends, or combinations and mixtures thereof. In addition, any given resin substrate or sheet can include one or more resin-based substrates and any number other layers or coatings.

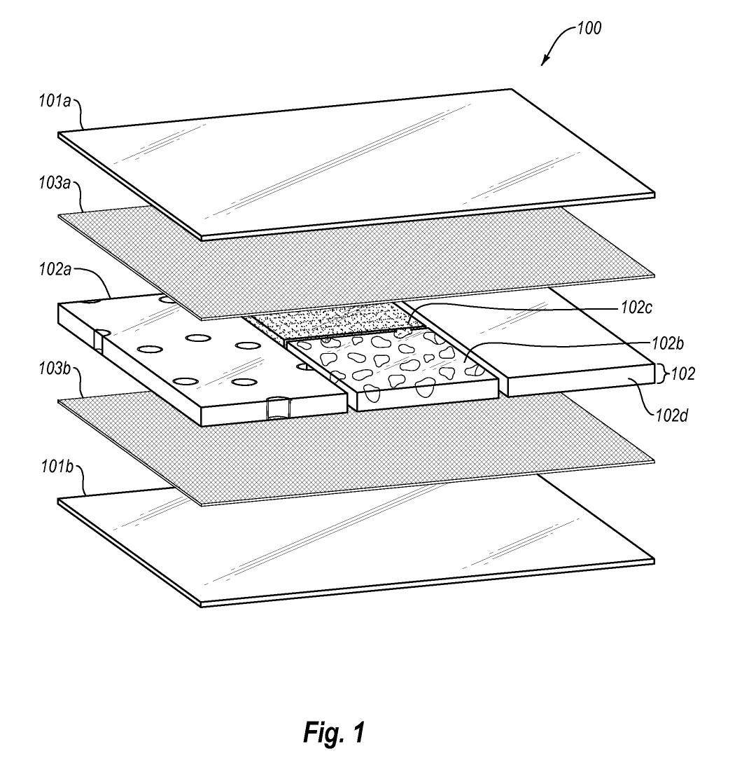

Referring now to the Figures, FIG. 1 illustrates an exploded perspective view the layers of a variable interlayer laminate panel assembly 100 in accordance with an implementation of the present invention. As shown, the variable interlayer laminate panel assembly 100 includes a first resin substrate 101a and an opposing second resin substrate 101b, each forming opposite outer layers of the variable interlayer laminate panel assembly 100. At least one of the resin substrates (101a and/or 101b) preferably comprises a substantially transparent resin material, thereby providing a view of a variable interlayer 102 positioned between the first and second resin substrates 101a, 101b. The variable interlayer 102 comprises a plurality of independent resin portions (e.g., resin portions 102a, 102b, 102c, and 102d) which can also be at least partially transparent and/or include decorative features. While four resin portions are illustrated, the variable interlayer 102 can include any number of resin portions (i.e., two or more) positioned in any arrangement, but typically in an arrangement that achieves a desired aesthetic effect.

As discussed more fully herein after, the resin portions (e.g., one or more of resin portions 102a, 102b, 102c, and 102d) can comprise resin portions sourced from one or more other resin panels. For instance, the resin portions can comprise waste trimmings left over from the manufacture of other resin panels, which can result in a variable interlayer 102 (and consequently a resin panel 100) having a potentially high percentage of recycled content. The resin portions can also comprise non-waste portions of other resin panels. In one or more implementations, the resin portions include at least some resin portions sourced from different resin panels, each having different aesthetic characteristics. The plurality resin portions can thus include a variety of aesthetic qualities (e.g., embedded decorative elements, colors, transparency), enabling a manufacturer to combine resin portions from different resin panels to create a variable interlayer 102 having distinctive aesthetic arrangements.

FIG. 1 also illustrates that the variable interlayer laminate panel assembly 100 can optionally include one or more air transfer layers 103a and/or 103b. When using air transfer layers, a manufacturer typically positions each air transfer layer 103a, 103b between the variable interlayer 102 and an outer layer (e.g., 101a, 101b). The air transfer layer(s) 103a and/or 103b preferably comprise a material suited for transporting air out of the resin panel 100 during a lamination or fusing process (described herein after), which fuses the various resin components to one another. The air transfer layer(s) 103a and/or 103b can thereby reduce the occurrence of air bubbles trapped within the variable interlayer laminate panel after lamination or fusing. Preferably, the material used in the air transfer layer(s) 103a and/or 103b is also suited for becoming virtually invisible in the finished resin panel 100, so that it does not substantially obscure a view of the variable interlayer 102.

In one or more embodiments, the air transfer layer(s) 103a and/or 103b comprise spunbound polyester, which includes fibers that create pathways through which air can travel during the fusing process. As a result, pressures (e.g., mechanical and/or vacuum pressure) applied during the fusing process can push and/or pull air out of the laminate panel through these pathways. Furthermore, heat applied during the fusing process melts the fibers, making them substantially undetectable to the human eye. Manufacturers can employ any number of other air transport materials, so long as they enable the transport of air out of the variable interlayer laminate panel assembly 100 and/or do not substantially interfere with the translucent or transparent properties of the layers of the variable interlayer laminate panel assembly 100.

Manufacturers can vary the thickness of each layer in the variable interlayer laminate panel assembly 100 to optimize various characteristics of the finished panel. For example, a manufacturer or consumer may want to maximize the amount of recycled content of the variable interlayer 102 in order to accumulate LEED points for a given project, or to market the resin panel 100 as being environmentally friendly. In this case, the manufacturer may construct the variable interlayer 102 from waste trimmings, and/or increase the thickness of the variable interlayer 102 in relation to the outer layers, thereby increasing the percentage of recycled content in the resin panel 100 on a mass basis. An additional benefit of using waste trimmings for the variable interlayer 102 is an overall decrease in the material cost for the resultant variable interlayer laminate panel, since the manufacturer need not purchase new resin for the variable interlayer 102. The manufacturer can also increase the amount of recycled content of the variable interlayer laminate panel assembly 100 by using resin substrates 101a, 101b that are at least partially comprised of pre-consumer or post-consumer recycled resins.

Decreasing the thickness of the resin substrates 101a, 101b may lead to an increased occurrence of surface blemishes on the finished variable interlayer laminate panel. As a result, the manufacturer can generally only decrease the thickness of the resin substrates 101a, 101b to a certain threshold. This threshold is generally a dynamic threshold, which varies based on a ratio between the thicknesses of the variable interlayer 102 and the thickness of the outer resin substrates 101a, 101b.

In one or more implementations, variable interlayer laminate panels in accordance with the present invention can have about 60%, 65%, 70%, 75%, 80%, 85%, 90%, 95%, or about 100% by weight (or alternatively by volume) of pre-consumer recycled content. For example, a variable interlayer laminate panel having approximately 75% recycled material could include a variable interlayer 102 having a substantially uniform thickness of about ¼ inch (e.g., 0.263 inches) and comprising 100% recycled waste trimmings. The resin variable interlayer laminate panel could also include two resin substrates 101a, 101b forming outer layers, each having a thickness of about 1/10 inch (e.g., 0.090 inches). The resin substrates 101a, 101b can also include some recycled content, such as about 40%. The variable interlayer laminate panel, when manufactured according to these specifications, would have an overall thickness of less than ½ inch. Any air transfer layer(s) 103a and/or 103b would add negligible thickness and mass to the finished resin panel.

Of course, manufacturers can use other thicknesses and/or other levels of recycled content. For example, in one or more implementations the variable interlayer 102 can have a thickness of about ⅜ inch. Additionally, one or more of the resin substrates 101a, 101b or the variable interlayer 102 can use a lower amount of recycled material (or even no recycled material) or a higher amount of recycled material. Accordingly, the above-illustrated example if for illustration only and is non-limiting.

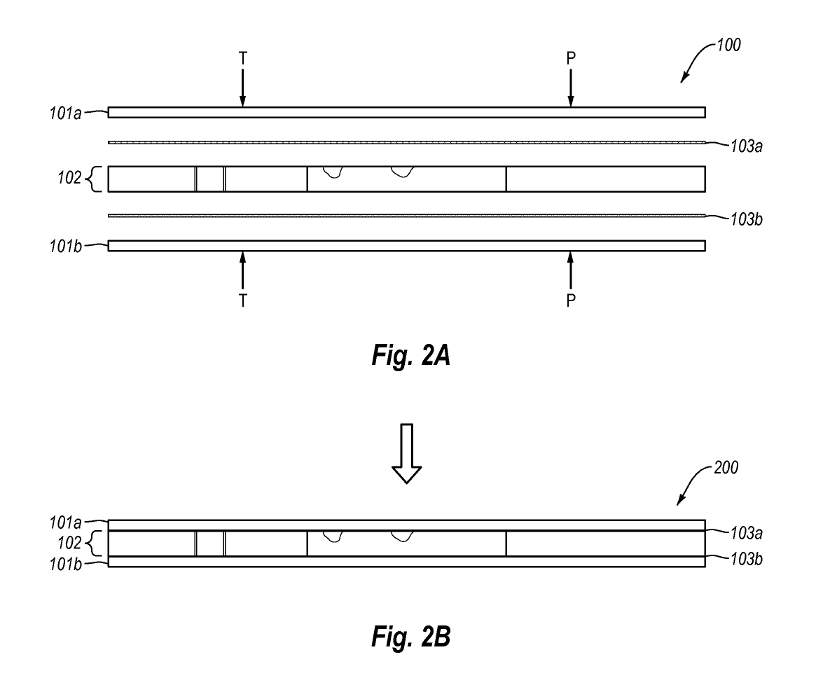

Turning to FIGS. 2A-2B, illustrated are side views of the variable interlayer laminate panel assembly 100 of FIG. 1 as it undergoes the lamination or fusing process. As shown in FIG. 2A, a manufacturer can assemble a variable interlayer laminate panel assembly 100 by positioning the variable interlayer 102 over the bottom resin substrate 101b, and by then positioning the top resin substrate 101a over the variable interlayer 102. As described and illustrated previously, the variable interlayer 102 can comprise a plurality of independent resin portions (e.g., portions 102a-102d of FIG. 1), which can potentially be sourced from one or more other resin panels. Optionally, the manufacturer can also position one or more air transport layers 103a, 103b within the panel assembly to help transport air out of the panel assembly during the fusing process, reducing the incidence of air bubbles in the finished variable interlayer laminate panel. The manufacturer may also employ an adhesive (e.g., a spray or roll-applied liquid adhesive that cures at or substantially near ambient room temperature, or a film adhesive) to hold the variable interlayer laminate panel assembly 100 together prior to and during the lamination/fusing process.

After assembling the variable interlayer laminate panel assembly 100, the manufacturer can laminate/fuse the resin components of the variable interlayer laminate panel assembly 100 together through the application of heat and pressure. For instance, as shown, the manufacturer can raise the temperature (T) and the pressure (P) of the variable interlayer laminate panel assembly 100, thereby melting the resin components beyond their glass transition temperature. Doing so fuses adjoining resin portions of the variable interlayer 102 to one another, and also fuses the variable interlayer 102 and the resin substrates 101a, 101b to one another. The particular temperature (T) and pressure (P) employed are dependent on the types of resins used, the thicknesses of the substrates 101a, 101b and the variable interlayer 102, and whether the manufacturer uses adhesives and/or air transport layers 103a, 103b. FIG. 2B illustrates a finished and fused variable interlayer laminate panel 200.

In one or more implementations, the manufacturer can apply a temperature of between about 180 degrees Fahrenheit (° F.) and about 400° F., and apply a pressure between approximately 5 pounds per square inch (psi) and approximately 250 psi. Preferably, the pressure is between about 5 psi and about 90 psi. The manufacturer can hold the variable interlayer laminate panel assembly 100 at the appropriate temperature and pressure until the resin components fuse, such as for about 0.1 minutes to about 20 minutes. The manufacturer can apply heat and pressure using any appropriate mechanism, such as with a heated mechanical press or with an autoclave. When heating with a heated mechanical press, the manufacturer can make use of various heating methods, including steam, electric heat, heated oil, etc.

The manufacturer may also employ a vacuum to remove air from the variable interlayer laminate panel assembly 100. For example, the manufacturer can reduce the air pressure prior surrounding the variable interlayer laminate panel assembly 100 prior to pressing with a mechanical press or autoclave. Additionally or alternatively, the manufacturer can make use of a mechanical press that applies pressure to the variable interlayer laminate panel assembly 100 mechanically, while concurrently reducing the air pressure around the panel assembly to aid in removing air from the panel assembly.

Following the application of heat and pressure, the manufacturer can allow the laminated/fused variable interlayer laminate panel 200 to cool below the glass transition temperature of the resin material while holding the panel assembly rigid. For instance, the manufacturer can reduce the temperature of the variable interlayer laminate panel 200 to between about 50° F. about 120° F., and hold the panel assembly at a pressure of between about 1 psi and about 120 psi. Once the variable interlayer laminate panel 200 cools below the glass transition temperature, the manufacturer can remove the fused variable interlayer laminate panel 200 from the pressing mechanism.

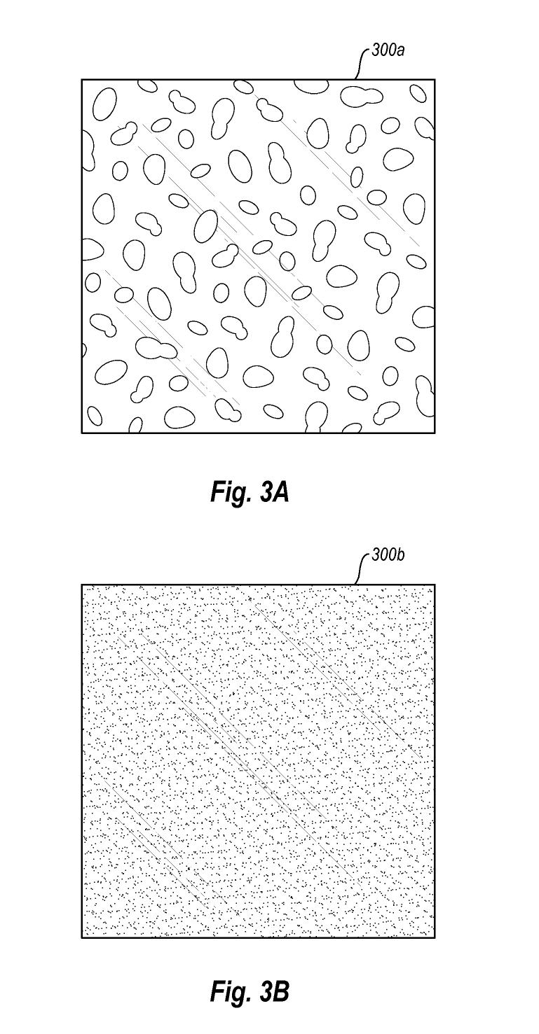

As indicated, the manufacturer can source the resin portions (e.g., resin portions 102a, 102b, 102c, and 102d of FIG. 1) used in the variable interlayer 102 from waste trimmings or non-waste portions of other resin panels. FIG. 3A shows that an exemplary resin panel 300a, which a manufacturer may utilize as a building material for decorative or structural purposes, may contain a plurality of embedded discrete decorative elements, such as the illustrated coffee beans. One will appreciate, however, that the resin panel 300a may embed any variety of resin and/or non-resin decorative elements. For example, the resin panel 300a may embed limitless combinations of geometric shapes, cross sections, rings, patterns, arches, metal hardware, flattened leaves, ferns, cutout designs, fabrics, thatch, willow reed, straw, coffee beans, twigs, bamboo, and so forth. The resin panel 300a can be substantially transparent or translucent, providing at least a partial view of the embedded decorative elements and causing the resin panel 300a to exhibit distinct visual aesthetic characteristics.

In one or more implementations, however, the other resin panels may not embed decorative materials. For example, FIG. 3B illustrates an exemplary resin panel 300b that lacks any embedded decorative materials. Instead, resin panel 300b may include combinations of surface textures or graphic and/or color film bonded to or formed on an outer surface of the resin panel 300b. The resin panel 300b may exhibit varying levels of translucence to create desired aesthetic effects. Panels similar to resin panel 300b may include single piece of clear or colored resin material, or may be formed a variable number of resin sheets laminated together.

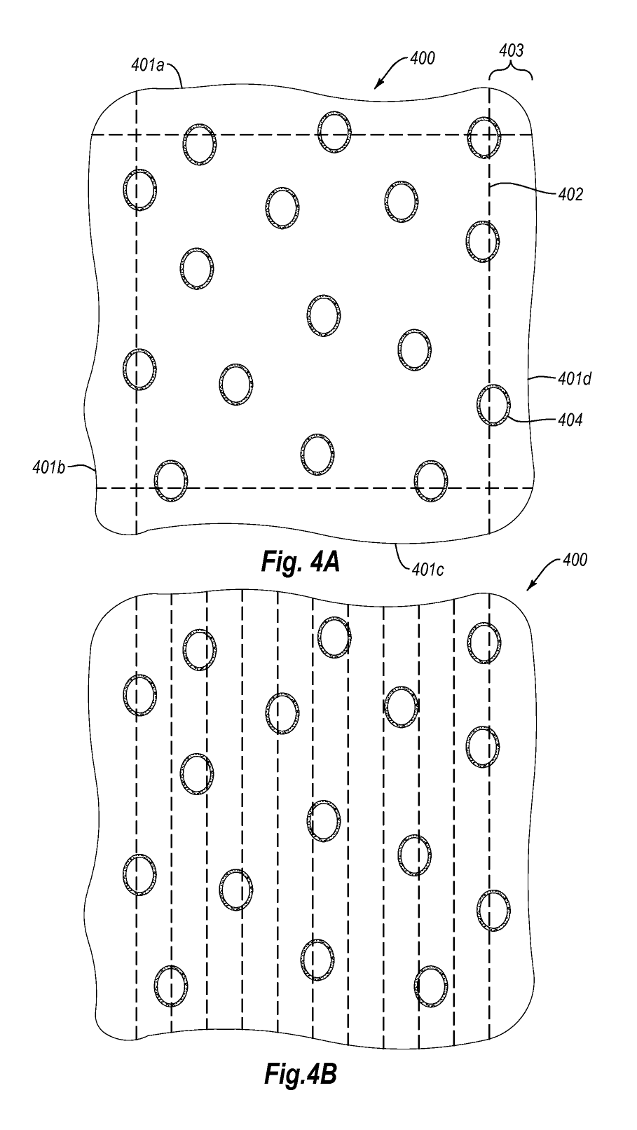

As illustrated, resin panels 300a and 300b have already been finished, or trimmed to size. FIG. 4A, however, illustrates a top view of a decorative resin panel 400, containing embedded bamboo cross sections, that a manufacturer has formed (e.g., laminated/fused through the application of pressure and heat) but has not yet finished. Thus, one or more edges 401a, 401b, 401c, and/or 401d of the resin panel 400 may need further processing to finish the panel 400. As shown, for example, each of edges 401a, 401b, 401c, and/or 401d exhibit unevenness; but depending on the manufacturing process some of the edges may actually be relatively straight and uniform. In any case, the manufacturer may trim one or more of the edges 401a, 401b, 401c, and/or 401d to create a smooth edge finish, to make the panel 400 fit within specified size parameters, and/or to square the corner angles of the panel 400.

For instance, the manufacturer may trim each panel edge, as illustrated by the dashed lines, resulting in waste trimmings that may include decorative materials. For example, when the manufacturer trims edge 401d at dashed line 402, the waste trimming 403 contains a portion of a bamboo ring 404. Because there can be limitless configurations of decorative materials within the panel 400, the waste trimming 403 can, in turn, contain a vast array of unique aesthetic qualities. For example, the waste trimming 403 may contain no decorative materials, or may contain entire pieces of decorative material and/or mere portions of decorative material. The manufacturer may choose not to trim every panel edge, or may use differing trimming configurations, such as curves, saw tooth configurations, or any other decorative form.

In addition, the manufacturer may trim each edge more than once. In one or more implementations, trimming an edge may involve a first “rough” trimming process that yields fast yet less precise or less clean cut, and one or more subsequent trimming processes that gradually refine the edge. It is therefore possible for the trimming of a single resin panel to generate a variety of waste trimmings having various widths and geometries. The manufacturer can use any of these waste trimmings as one of the plurality of resin portions (e.g., 102a-102d) that form the variable interlayer 102 of the variable interlayer laminate panel 200.

Manufacturers may also use portions of decorative panels not normally classified as waste to construct the variable interlayer laminate panel 200. For instance, manufacturers may produce or purchase resin panels, such as resin panels 300a, 300b, or 400, for the purpose of generating “non-waste” trimmings for use as the resin portions (e.g., 102a-102d) that form the variable interlayer 102. Along these lines, FIG. 4B, illustrates an alternative cutting pattern that the manufacturer may use when cutting the resin panel 400 of FIG. 4A, in which the parallel dashed lines illustrate that the manufacturer cuts the panel 400 into a plurality of strips. The manufacturer may then use each strip as a resin portion in the production of a laminate panel, such as panel 100 of FIG. 1. One will appreciate that the parallel dashed lines are for illustrative purposes only, and that the manufacturer may employ a limitless variety of cut patterns to create various resin portion geometries.

Use of resin portions sourced from other resin panels enables manufacturers to “mix-and-match” resin portions from different resin panels having distinct and different designs. Manufacturers can therefore fabricate a variable interlayer laminate panel 200 having a plurality of different types of decorative elements embedded therein, without complicating the processes of embedding those decorative materials in variable interlayer laminate panel 200. Because of the aesthetic appeal of such arrangements, manufacturers may produce panels (e.g., panels 300a, 300b, or 400) for the express purpose of later dividing at least a portion of these panels into smaller pieces for later re-assembly as a variable interlayer 102. Therefore, in addition to enabling manufacturers to reduce waste and produce environmentally-friendly panels, the inventive implementations described herein also enable great flexibility in producing distinctive designs.

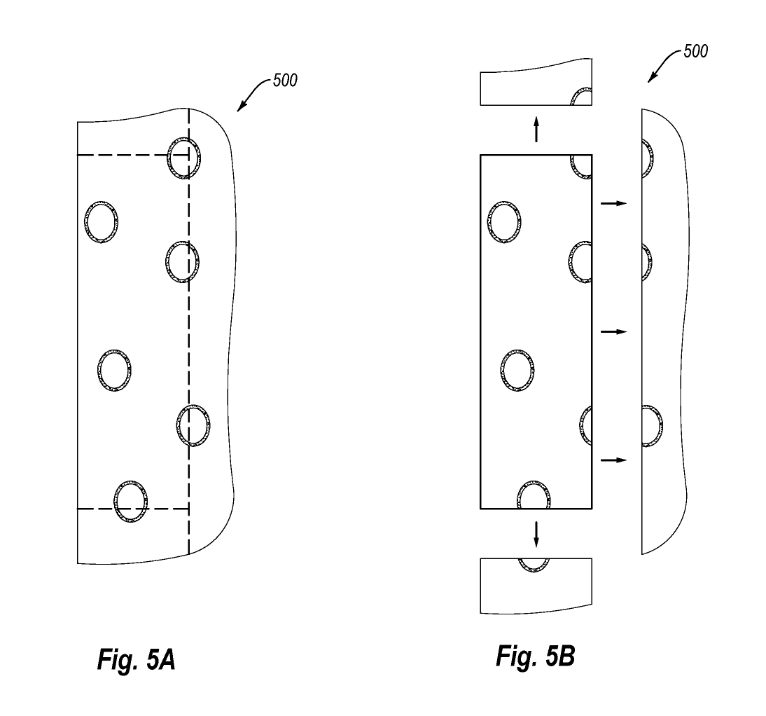

It may be possible to use waste or non-waste trimmings in the production of a variable interlayer laminate panel 200 without any additional modification to the edges of the trimmings. It may be desirable; however, to further modify the trimmings for use in the variable interlayer 102. FIG. 5A, for example, illustrates a trimming 500 sourced from an edge of panel 400, which has a straight edge and three untrimmed edges. The trimming 500 may be a waste trimming resulting from finishing panel 400 as in FIG. 4A, or it may be a non-waste edge piece resulting from dividing panel 400 as in FIG. 4B. Either way, to eliminate gaps between the resin portions in the variable interlayer 102, the manufacturer may further trim the trimming 500 along the illustrated dashed lines so that it has a desired geometric shape (a rectangle, as shown in FIG. 5B).

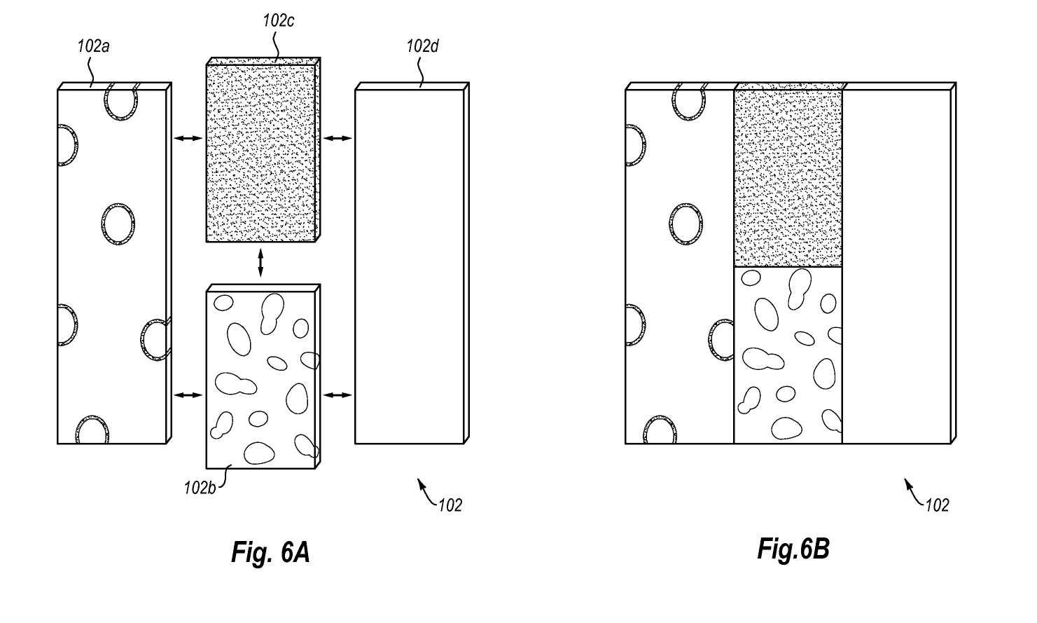

FIGS. 6A-6B further illustrate the variable interlayer 102 of FIG. 1. As shown, following any trimming, the manufacturer may arrange the resin portions (e.g., 102a-102d) to form the decorative interlayer 102. FIG. 6A shows that the manufacturer can arrange the resin portions 102a-102d so that the edges of the resin portions come into substantial contact. These portions can include a diversity of colors, patterns, decorative elements, sizes, shapes, and arrangements. FIG. 6B shows the variable interlayer 102 after arrangement.

While FIGS. 6A-6B illustrate resin portions having uniform width and arranged in rows, other arrangements are possible, such as a variable interlayer 102 having rows of varying widths, or even arrangements lacking rows/columns altogether. For instance, arrangements may include an ordered or random sequence of rectangles of varying size. The resin portions need not embody rectangular geometries. For example, one or more of the resin portions may include other geometric shapes (e.g., stars, moons, circles, triangles, etc.) or silhouette cutouts that may be familiar to an observer. The resin portions that surround these shapes may have the inverse geometry on any bordering edge, such that the resin portions fit together without substantial gaps there between.

It will be appreciated that the resin portions sourced from other resin panels can comprise single or multi-layer resin portions. For instance, the other resin panels may include multiple layers, such as outer layers, interlayers, decorative resin layers, decorative films, air transport layers, adhesives, etc. As such, resin portions sourced from these panels may also include these layers. In one or more implementations, the other resin panels may even be manufactured according to the implementations described herein.

As shown by FIG. 6B, at least two more of the resin portions 102a-102d of the variable interlayer 102 can include different decorative objects or designs. For example, resin portion 102a includes bamboo cross sections, resin portion 102b includes coffee beans, resin portion 102c includes a colored film, and resin portion 102d is transparent. Additionally, or alternatively, the two or more of the resin portions of a variable interlayer of a variable interlayer laminate panel can include the same or different types of decorative objects (thatch, bark, grass, yarn, leaves, flowers, crushed glass, shells, bamboo, metal rod, wood veneer, film layers, textiles, etc.) with different concentrations, orientation, and/or sizes.

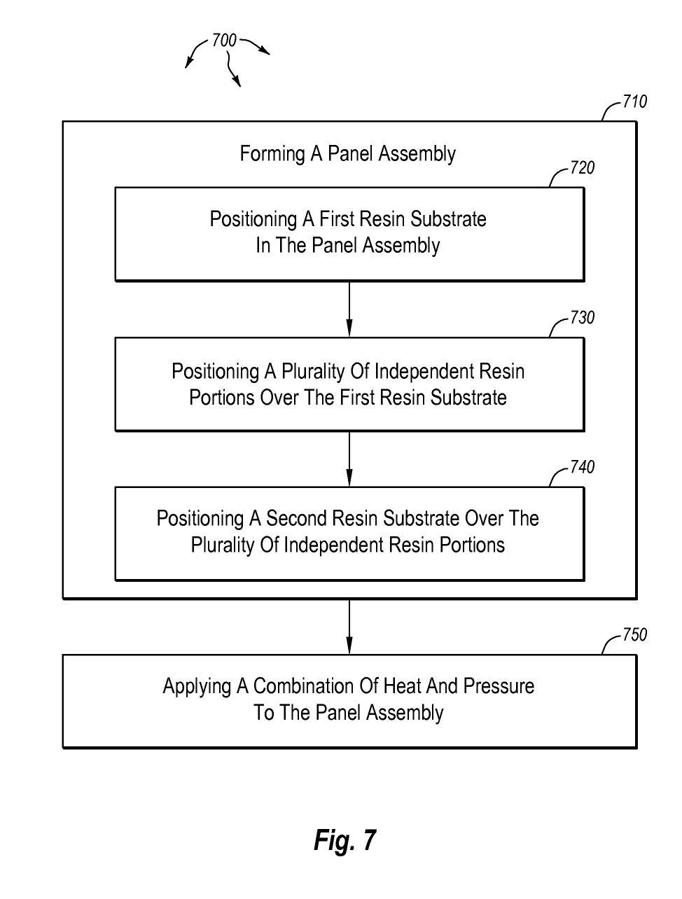

Accordingly, FIGS. 1-6B, the corresponding text, and the examples, provide a number of different components and mechanisms for creating decorative variable interlayer laminate panels produced from existing resin portions, such as recycled waste trimmings. In addition to the foregoing, implementations of the present invention can also be described in terms of flowcharts comprising acts and steps in a method for accomplishing a particular result. For example, FIG. 7 illustrates a flowchart of one exemplary method for manufacturing a variable interlayer laminate panel using independent resin portions. The acts of FIG. 7 are described below with reference to the components and diagrams of FIGS. 1 through 6B.

For example, FIG. 7 shows that the method of 700 manufacturing a variable interlayer laminate panel can comprise an act 710 of forming a panel assembly. Act 710 can include forming a panel assembly for the variable interlayer laminate panel. For example, as illustrated in FIGS. 1, 2A, and 2B, a manufacturer can form a variable interlayer laminate panel assembly 100 for the production of variable interlayer laminate panel. The variable interlayer laminate panel assembly 100 can comprise a plurality of layers of resin material, as well as layers of non-resin material. The manufacturer may source at least some of the resin material from waste trimmings or from non-waste trimmings of other resin panels.

FIG. 7 shows that the act 710 of forming a panel assembly can comprise and act 720 of positioning a first resin substrate in the panel assembly. For example, as shown in FIGS. 1, 2A, and 2B, the manufacturer can form a first outer layer of a variable interlayer laminate panel assembly 100 using resin substrate 101b. In one or more implementations, the resin substrate 101b may comprise a substantially transparent resin material, and/or may comprise at least some recycled content.

FIG. 7 also shows that the act 710 of forming a panel assembly can comprise and act 730 of positioning a plurality of independent resin portions over the first resin substrate. Act 730 can include positioning a plurality of independent resin portions 102a-102d over the first resin substrate 101b in the variable interlayer laminate panel assembly 100, each of the plurality of independent resin portions comprising one or more embedded decorative elements, wherein at least two different resin portions comprise different types of decorative elements. For example, as shown in FIG. 1, the manufacturer can form the variable interlayer 102 using a plurality of resin portions (102a-102d). As further shown in FIGS. 3A-5B, the manufacturer can source these resin portions from other resin panels (e.g., panels 300a, 300b and/or 400), as waste and/or non-waste trimmings.

While not shown, act 730 can involve further trimming the resin portions to that they fit cleanly with one another and so that they fit within a desired arrangements. As shown in FIGS. 6A-6B, the arrangement may comprise and arrangement of rows and/or columns, but the arrangement can take virtually any form using virtually any geometric shapes. At least some of the resin portions can include one or more embedded decorative elements, and at least two different resin portions, sourced from different resin panels, can contain decorative elements of differing shapes, materials, etc.

FIG. 7 further shows that the act 710 of forming a panel assembly can also comprise and act 740 of positioning a second resin substrate over the plurality of independent resin portions. In particular act 740 can include positioning a second resin substrate over the plurality of independent resin portions in the panel assembly. For example, as shown in FIGS. 1, 2A, and 2B, the manufacturer can form a second opposite outer layer of resin panel 100 using resin substrate 101a. In one or more implementations, the resin substrate 101a may also comprise a substantially transparent resin material, and/or may comprise at least some recycled content.

Although not shown, a manufacturer can also perform an act of positioning one or more air transport layers. In particular, the act may include positioning one or more air transport layers between one or both of the plurality of independent resin portions and the first resin substrate and/or the plurality of independent resin portions and the second resin substrate in the panel assembly, wherein the one or more air transport layers transport air out of the panel assembly during the application of the combination of heat and pressure. For example, as shown in FIGS. 1, 2A, and 2B, the manufacturer can include one or more of air transport layers 103a and/or 103b. These layers can, in one more implementations, comprise a fibrous material that creates channels along which air may travel. The air transport material can possess the properties that it allows resin materials to fuse through the air transport material and/or that it becomes virtually transparent in the finished resin panel 100.

Also not shown, the manufacturer may position one or more decorative outer layers on one or both of the first resin substrate 101b and/or the second resin substrate 101b. In this way, the manufacturer can add additional color and/or texture to the resin panel 100. In one or more implementations, the decorative outer layers may comprise a film applied to the resin substrate(s).

Furthermore, FIG. 7 further shows the method can comprise an act 750 of applying a combination of heat and pressure to the panel assembly. Act 750 can include applying a combination of heat and pressure to the variable interlayer laminate panel assembly 100 until the plurality of independent resin portions fuse together and fuse to the first resin substrate and the second resin substrate. For example a manufacturer can use an autoclave or a mechanical press to raise the temperature and the pressure of the panel assembly. The manufacturer can use the autoclave or press to apply a temperature of between about 180° F. and about 400° F. and a pressure of between about 5 psi and about 250 psi for a time period of between about 0.1 minutes and about 20 minutes to the panel assembly. The manufacturer may also make the use a vacuum to lower the air pressure (either before or during pressing) to remove air from the panel assembly. Furthermore, after fusing the components of the panel assembly, the manufacturer can cool the variable interlayer laminate panel 200 while also holding it rigid, as described.

In one or more implementations, the method can comprise applying a second combination of heat and pressure to the panel assembly. In particular, after passing through a heat and pressure cycle as described above in relation to act 750, the manufacturer run the panel assembly through a second heat and pressure cycle of with a temperature of between about 180° F. and about 400° F. and a pressure of between about 5 psi and about 250 psi for a time period of between about 0.1 minutes and about 20 minutes. In particular, it may be desirable to run the panel assembly through a second heat and pressure cycle when using resin portions (102a-102d) having different gauges and/or sizes. In such implementations, the second heat and pressure cycle can help reduce surface variations and flaws in the final panel.

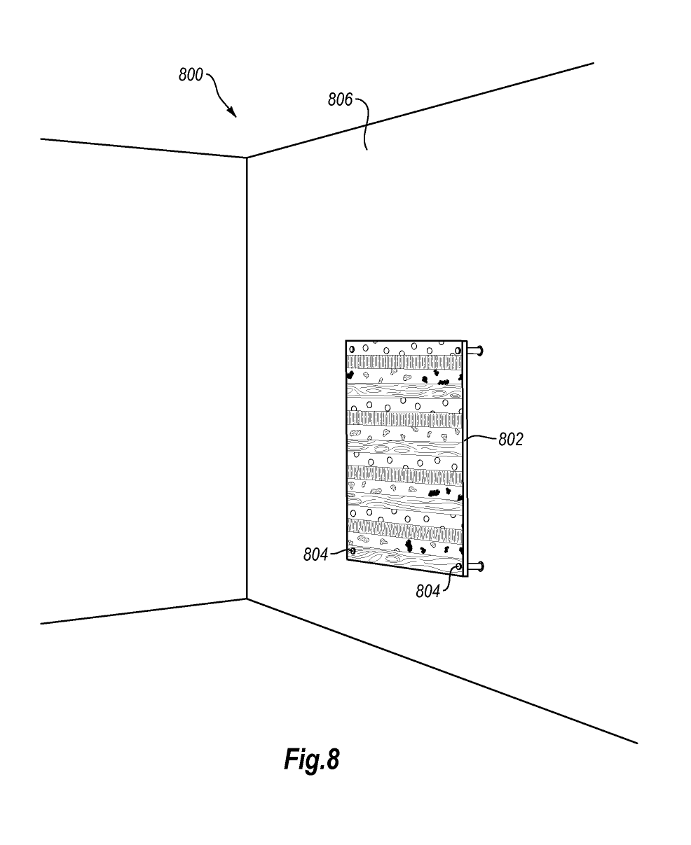

In any event, once formed, an end-user can arrange variable interlayer laminate panels produced as described herein into a panel system. For example, FIG. 8 illustrates a panel system 800 including a variable interlayer laminate panel 802 secured to a support structure 806 (i.e., wall) by a plurality of hardware components 804. As shown, the variable interlayer laminate panel 802 can include a variable interlayer comprising a plurality of resin portions extending across the width of the variable interlayer laminate panel 802. Each of the resin portions can include a variable interlayer (i.e., a different layout, type, size, concentration, or orientation) of decorative objects. In alternative implementations, the resin portions can extend across the height of the variable interlayer laminate panel 802.

In any event, panel system 800 can add to the functional and/or aesthetic characteristics of a given structure of design space. Thus, one will appreciate that implementations of the present invention provide a manufacturer with a number of ways to prepare a structurally useful, aesthetically desirable variable interlayer laminate panels. These variable interlayer laminate panels can have a wide range of shapes, sizes, thicknesses, properties or colors, and can be used in a wide range of environments and applications.

Accordingly, the schematics and methods described herein provide a laminate resin panel that can include resin material derived from other resin panels, enabling use of decorative resin pieces or portions from the other resin panels. The schematics and methods can also enable the recycling of waste trimmings from the manufacture of the other resin panels. Implementations therefore enable manufacturers to produce high-fashion but waste conscious resin panels that contain a high level of recycled content.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A variable interlayer laminate panel, comprising:
a first resin substrate;
an opposing second resin substrate; and
a variable interlayer positioned between and fused to the first resin substrate and the opposing second resin substrate, the variable interlayer comprising a plurality of resin portions, including:
a first resin portion that comprises a first embedded decorative element; and
a second resin portion that comprises a second embedded decorative element, differing the first embedded decorative element;
wherein the first resin portion and the second resin portion are fused to one another.

2. The variable interlayer laminate panel as recited in claim 1, wherein at least one of the plurality of resin portions comprises a waste resin portion resulting from fabrication of a different laminate panel.

3. The variable interlayer laminate panel as recited in claim 2, wherein the waste resin portion comprises a waste trimming resulting from finishing an edge of the different laminate panel.

4. The variable interlayer laminate panel as recited in claim 1, wherein at least one of the plurality resin portions comprises:
a first resin outer layer;
a decorative resin interlayer; and
an opposing second resin outer layer.

5. The variable interlayer laminate panel as recited in claim 4, wherein the decorative resin interlayer comprises one or more embedded decorative elements.

6. The variable interlayer laminate panel as recited in claim 1, wherein at least one of the plurality resin portions comprises a non-waste portion of a different laminate panel.

7. The variable interlayer laminate panel as recited in claim 1, further comprising one or more air transport layers positioned between the variable interlayer and one or more of the first resin substrate or the second resin substrate.

8. The variable interlayer laminate panel as recited in claim 7, wherein:
the one or more air transport layers comprise a fibrous material; and
the interlayer is fused to one or more of the first resin substrate or the second resin substrate through one of the one or more air transport layers.

9. The variable interlayer laminate panel as recited in claim 1, wherein the variable interlayer laminate panel comprises between about 60% and about 100% recycled material.

10. The variable interlayer laminate panel as recited in claim 9, wherein the variable interlayer laminate panel comprises about 75% recycled material.

11. The variable interlayer laminate panel as recited in claim 1, wherein the resin portions span across one of the width or the height of the variable interlayer laminate panel.

12. A method of manufacturing a variable interlayer laminate panel, comprising:
forming a variable interlayer laminate panel assembly, comprising:
positioning a first resin substrate;
positioning a plurality of independent resin portions over the first resin substrate, each of the plurality of independent resin portions comprising one or more embedded decorative elements, wherein at least two different resin portions comprise different types of decorative elements; and
positioning a second resin substrate over the plurality of independent resin portions; and
applying a combination of heat and pressure to the variable interlayer laminate panel assembly until the plurality of independent resin portions fuse together and fuse to the first resin substrate and the second resin substrate.

13. The method as recited in claim 12, further comprising:
positioning one or more air transport layers between the plurality of independent resin portions and one or more of the first resin substrate and the second resin substrate;
wherein the one or more air transport layers transport air out of the variable interlayer laminate panel assembly during the application of the combination of heat and pressure.

14. The method as recited in claim 13, wherein the plurality of independent resin portions fuse to one or more of the first resin substrate and the second resin substrate through the one or more air transport layers.

15. The method as recited in claim 12, wherein applying the combination of heat and pressure comprises applying:
a temperature of between about 180 degrees Fahrenheit and about 400 degrees Fahrenheit; and
a pressure of between about 5 pounds per square inch and about 250 pounds per square inch;
for a time period of between about 0.1 minutes and about 20 minutes.

16. The method as recited in claim 12, wherein positioning the plurality of independent resin portions over the first resin substrate comprises positioning at least one independent resin portion that comprises a waste resin portion resulting from fabrication of a different laminate panel.

17. The method as recited in claim 12, wherein at least one of the plurality of independent resin portions comprise one or more embedded decorative elements comprising non-resin material.

18. A panel system, comprising:
a variable interlayer laminate panel; and
one or more hardware structures that attach the variable interlayer laminate panel to a support structure;
wherein the variable interlayer laminate panel comprises:
a first resin substrate;
an opposing second resin substrate; and
a variable interlayer positioned between and fused to the first resin substrate and the opposing second resin substrate, the variable interlayer comprising a plurality of fused resin portions, including a first resin portion that comprises a first embedded decorative element and a second resin portion that comprises a second embedded decorative element that is of a different material than the first embedded decorative element.

19. The panel system as recited in claim 18, wherein at least one of the plurality of fused resin portions comprises a recycled resin portion left over from fabrication of another laminate panel.

20. The panel system as recited in claim 18, wherein the variable interlayer laminate panel comprises between about 60% and about 100% recycled material.
